(19) United States
(12) Patent Application Publication
(10) Pub. No.: US 2004/0252005 A1
(43) Pub. Date: Dec. 16, 2004

(54) Shape memory alloy MEMS component deposited by chemical vapor deposition

(75) Inventors: Robert L. Villhard, Ballwin, MO (US); Robert J. Atmur, Whittier, CA (US)

Correspondence Address: GATES & COOPER LLP, HOWARD HUGHES CENTER, 6701 CENTER DRIVE WEST, SUITE 1050, LOS ANGELES, CA, 90045, US

(73) Assignee: The Boeing Company

(21) Appl. No.: 10/458,591

(22) Filed: Jun. 10, 2003

(51) Int. Cl. H01H 37/46; H01H 37/50

(52) U.S. Cl. 337/393; 337/395; 337/396

(57) ABSTRACT

An method and apparatus for dampening microelectromechanical system (MEMS) devices is disclosed. A typical method or apparatus embodiment of the invention includes a microelectromechanical system (MEMS) device including an actuator and a movable element and having a frequency response. A shape memory alloy (SMA) material is applied to the movable element of the MEMS device to provide passive damping to the frequency response of the MEMS device. The applied SMA material typically provides no actuation of the MEMS device. A chemical vapor deposition (CVD) process can be used to apply the SMA material.

### BACKGROUND OF THE INVENTION

1. Field of the Invention

The present invention relates to methods and apparatuses for dampening microelectromechanical system (MEMS) devices. Particularly, the present invention relates to methods and apparatuses for dampening microelectromechanical system (MEMS) devices using shape memory (SMA) materials.

2. Description of the Related Art

In recent years much effort has been expended in the development of viable MEMS devices for a variety of applications. Many manufacturing techniques for MEMS devices have been borrowed from developed electronics manufacturing processes. Naturally, the critical distinction between the two manufacturing methods arises from the fact that MEMS devices include moving components whereas most electronics do not. Thus, MEMS devices involve additional problems related to actuation of their moving parts.

Actuation for MEMS is a fundamental requirement. Accordingly, most emphasis is given to the refinement and development of various actuation tools for MEMS devices. For example, electrostatic, piezoelectric and shape memory alloy (SMA) actuation have been studied. See e.g., U.S. Pat. No. 5,061,914 which applies to SMA actuation and TiNi Alloy Company White Paper Recommendations for NIST ATP Focused Microfabrication Program, http://www.sma-mems.com/nistpapr.htm, 1997, which are incorporated by reference herein.

In the pursuit of finding actuators to drive MEMS devices, not much recognition or study has been given to the need for dampening the movements of such MEMS device, i.e. controlling the movement apart from actuating.

There is a need in the art for methods and apparatuses to dampen MEMS devices. Particularly, there is a need for such methods and apparatuses to function passively. Further, there is a need for such methods and apparatuses to be inexpensive and simple to apply using known fabrication techniques. These and other needs are met by embodiments of the present invention.

### SUMMARY OF THE INVENTION

A typical method or apparatus embodiment of the invention includes a microelectromechanical system (MEMS) device including an actuator and a movable element and having a frequency response. A shape memory alloy (SMA) material is applied to the movable element of the MEMS device to provide passive damping to the frequency response of the MEMS device. The applied SMA material typically provides no actuation of the MEMS device. A chemical vapor deposition (CVD) process can be used to apply the SMA material.

The actuator can be any type of acceptable MEMS actuator, including but not limited to, an SMA actuator, an electrostatic actuator, a bimetal actuator or a piezoelectric actuator. The movable element of the MEMS device can include a surface that is strained in operation. The SMA material is applied over the strainable surface to impart passive damping to the MEMS device in operation.

SMA materials have been employed to assist dampening of large structural members, however, not for MEMS devices. For example, a discussion of SMA materials applied to assist dampening turbo machinery blades is provided in co-pending U.S. patent application Ser. No. 10/080,208 by Robert Villhard, filed Feb. 19, 2002 and entitled “BLADES HAVING COOLANT CHANNELS LINED WITH A SHAPE MEMORY ALLOY AND AN ASSOCIATED FABRICATION METHOD” (Attorney Docket No. 38190/242520) and U.S. patent application Ser. No. XX/XXXXXX by Robert Villhard, filed Apr. 4, 2003 and entitled “METHOD OF FABRICATING A SHAPE MEMORY ALLOY DAMPED STRUCTURE”, which are incorporated by reference herein.

Typically, the process of depositing the SMA damper on the MEMS device may include a CVD or PVD (sputtering) step. Depending upon the particular application, various SMA materials can be used, including but not limited to Ag—Cd, Au, Cd, Cu—Al—Ni, Cu—Sn, Cu—Zn, In—Ti, Ni—AL, Ni—Ti, Fe—Pt, Mn—Cu and Fe—Mn—Si alloys.

In typical embodiments of the invention, the SMA material is applied to have a transition temperature substantially near an operating temperature of the MEMS device. In further embodiments, the SMA material can have a temperature approximately controlled to the transition temperature of the SMA material. The temperature of the SMA material can be controlled using an electric heater or cooler in a temperature-sensed feedback control system.

Furthermore, in one particular optical switch embodiment, the movable element can comprise a mirrored surface coupled to the actuator. The SMA material then damps motion of the mirrored surface. Such a switch can be employed in fiber optic applications, such as communications.

### BRIEF DESCRIPTION OF THE DRAWINGS

Referring now to the drawings in which like reference numbers represent corresponding parts throughout:

FIG. 1 is a flowchart of an exemplary application method of the invention;

FIG. 2A illustrates an exemplary embodiment of the invention for a optical switch;

FIG. 2B illustrates a top view of the exemplary embodiment of the invention for a optical switch;

FIG. 2C-2D illustrate a side view of the exemplary embodiment of the invention for a optical switch; and

FIG. 3 is a block diagram of an exemplary embodiment of a temperature controlled MEMS device chip including an SMA damper.

### DETAILED DESCRIPTION OF THE PREFERRED EMBODIMENT

In the following description of the preferred embodiment, reference is made to the accompanying drawings which form a part hereof, and in which is shown by way of illustration specific embodiments in which the invention may be practiced. It is to be understood that other embodiments may be utilized and structural changes may be made without departing from the scope of the present invention.

1. Exemplary Application Methods of the Invention

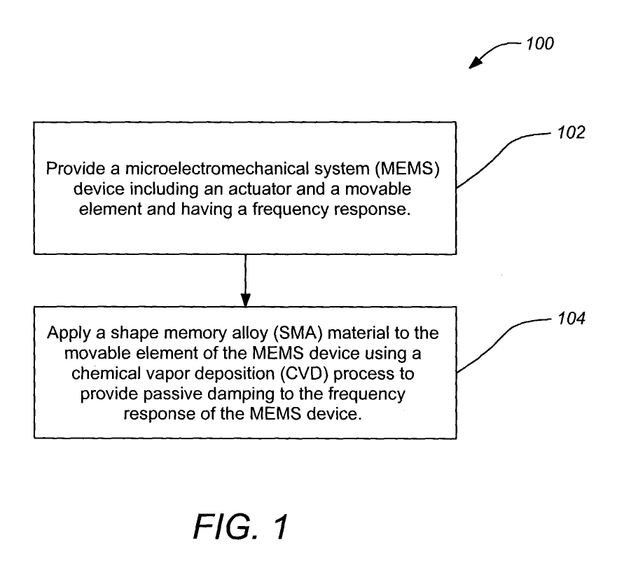

FIG. 1 is a flowchart of an exemplary application method of the invention. The method 100 begins at step 102 by providing a microelectromechanical system (MEMS) device including an actuator and a movable element, the system having a frequency response as provided. Next at step 104, a shape memory alloy (SMA) material is applied to the movable element of the MEMS device using a chemical vapor deposition (CVD) process to provide passive damping to the frequency response the MEMS device. The applied SMA material typically provides no actuation of the MEMS device.

Shape memory alloys are well known for exhibiting a dramatic change in their properties with temperature. SMA materials have a number of identified transition temperatures. Three significant temperatures are identified for an SMA material, the As temperature at which the SMA material starts transforming to austenite, the Ap temperature at which the SMA material is about half transformed (as measured on a differential scanning calorimeter curve) and the Af temperature at which the SMA material finishes transforming to austenite. Similarly, three significant temperatures are identified for cooling an SMA material, the Ms temperature at which the SMA material starts transforming back to martensite, the Mp temperature at which the SMA material is about half transformed to martensite and the Mf temperature at which the SMA material is finished transforming to martensite. See e.g., NITI SMART SHEETS, Nitinol Information at www.sma-inc.com, 1999, which are incorporated by reference herein, for further details regarding various transition temperatures and properties of SMA materials. Important to the present invention, SMA materials often exhibit a superelastic property at a temperature just below the Af temperature.

Though scope of the present invention encompasses embodiments in which the applied SMA may act as both an actuator and a damper (for instance, by applying heating or cooling to the SMA material it may act as an actuator), by instead holding the SMA material at or near its transition temperature, the SMA may absorb vibrational energy from the actuator, thereby acting to damp the actuator. When used as a damper, the SMA material alters the frequency response of the system, thereby enabling MEMS applications that were previously impractical.

Some known SMA materials that can be used in embodiments of the invention include Ag—Cd, Au, Cd, Cu—Al—Ni, Cu—Sn, Cu—Zn, In—Ti, Ni—AL, Ni—Ti (also known as Nitinol), Fe—Pt, Mn—Cu and Fe—Mn—Si alloys. In addition, Niobium-Ruthenium and Tantalum-Rhenium, which are known to have transition temperatures up to 1420° C., can also be used in embodiments of the invention. (See section 3. Operating Temperature and Selection of the Shape Memory Alloy, hereafter.)

Application of the SMA material is typically accomplished through the use of known chemical vapor deposition process. As used herein, chemical vapor deposition (CVD) is a generic name for a group of processes that involve depositing a solid material from a gaseous phase. Some CVD processes that can be used to apply SMA material in embodiments of the invention include, but are not limited to, atmospheric pressure chemical vapor deposition (APCVD), low pressure chemical vapor deposition (LPCVD), metal-organic chemical vapor deposition (MOCVD), plasma assisted chemical vapor deposition (PACVD) or plasma enhanced chemical vapor deposition (PECVD), laser chemical vapor deposition (LCVD), photochemical vapor deposition (PCVD) and chemical vapor infiltration (CVI). In general, application processes which are used to apply SMA materials in order to form actuators will also be applicable to embodiments of the present invention in order to form dampers. For example, U.S. Pat. No. 5,061,914 which applies to SMA actuation and TiNi Alloy Company White Paper Recommendations for NIST ATP Focused Microfabrication Program, http://www.sma-mems.com/nistpapr.htm, 1997, which are incorporated by reference herein, disclose applicable SMA material application techniques.

In CVD processes generally, precursor gases (often diluted in carrier gases) are delivered into the reaction chamber at controlled temperatures. As they pass over or come into contact with a warmer substrate, they react or decompose to form a solid phase which deposited on the substrate. The substrate temperature is critical and can influence what reactions will take place.

Typically, CVD coatings are fine grained with a high purity and harder than similar materials produced using conventional ceramic fabrication processes. CVD coatings are usually only a few microns thick and are generally deposited at fairly slow rates, usually of the order of a few hundred microns per hour.

A typical CVD application apparatus will consist of several basic components including a reactor chamber in which deposition takes place and a gas delivery system to supply precursors to the reactor chamber. A substrate loading mechanism introduces and removes such things as substrates and mandrels. An energy source provides the energy or heat required at the substrate surface to cause the precursors to react/decompose. Concurrently, a vacuum system is used to remove all other gaseous species other than those required for the reaction (deposition) prior to beginning the deposition process. During the process an exhaust system is used to remove volatile by-products from the reaction chamber. In some cases, exhaust treatment systems are used because exhaust gases may not be suitable for release into the atmosphere and may require treatment or conversion to safe compounds. Finally, process control equipment such as gauges, controls are used to monitor process parameters such as pressure, temperature and time.

With respect to energy sources, there are several suitable sources of heat for CVD processes. These include resistive heating such as tube furnaces, radiant heating such as halogen lamps, radio frequency heating such as induction heating and lasers. In addition other possible energy sources may include UV-visible light or lasers as a source of photo energy.

Because materials are deposited from the gaseous state during CVD, the precursors for CVD processes must be volatile. However, the precursors must also be stable enough to be able to be delivered to the reactor. Generally precursor compounds will only provide a single element to the deposited material, with others being made volatile during the CVD process. However, sometimes precursors may provide more than one. Such materials simplify the delivery system, as they reduce the number of reactants required to produce a given compound.

Typical CVD precursor materials fall into a number of categories such as: halides, e.g. TiCl₄, TaCl₅, WF₆, etc., hydrides, e.g. SiH₄, GeH₄, AlH₃(NMe₃)₂, NH₃, etc., metal organic compounds, e.g. metal alkyls such as AlMe₃, Ti(CH₂tBu)₄, etc., metal alkoxides, e.g Ti(OiPr)₄, etc., metal dialylamides, e.g. Ti(NMe₂)₄, etc., metal diketonates, e.g. Cu(acac)₂, etc., metal carbonyls, e.g. Ni(CO)₄, etc. In addition, other precursor materials include a range of other metal organic compounds, complexes and ligands.

2. Exemplary MEMS Devices of the Invention

MEMS devices have been developed for a wide range of applications. Some general categories of devices include optical switches, RF switches such as microwave antenna switches and even video screen pixels.

In the absence of the present invention, actuators must be deliberately under sized to prevent undesirable overshoot (i.e., bouncing) of the actuator and actuated components. In the alternative, and in the absence of the present invention, such overshooting may be tolerated by providing a design margin in the overall system to compensate for the noise associated with the overshoot. Each alternative prevents optimization of the frequency response of the system. Moreover, the available bandwidth of such non optimized systems suffers accordingly. This leads to higher operating costs, less operational flexibility, and generally higher system costs, all accompanied by poor signal to noise ratios.

Typically, operational parameters for MEMS devices will be set at some level, e.g. 40 dB, above the noise floor. Thus, lowering the noise floor can improve the overall device performance, particularly the speed. Dampening with the present invention helps to lower the noise floor of MEMS device by reducing the delay from actuation until the MEMS device settles out. Embodiments of the present invention can be applied to any MEMS device which includes a movable element.

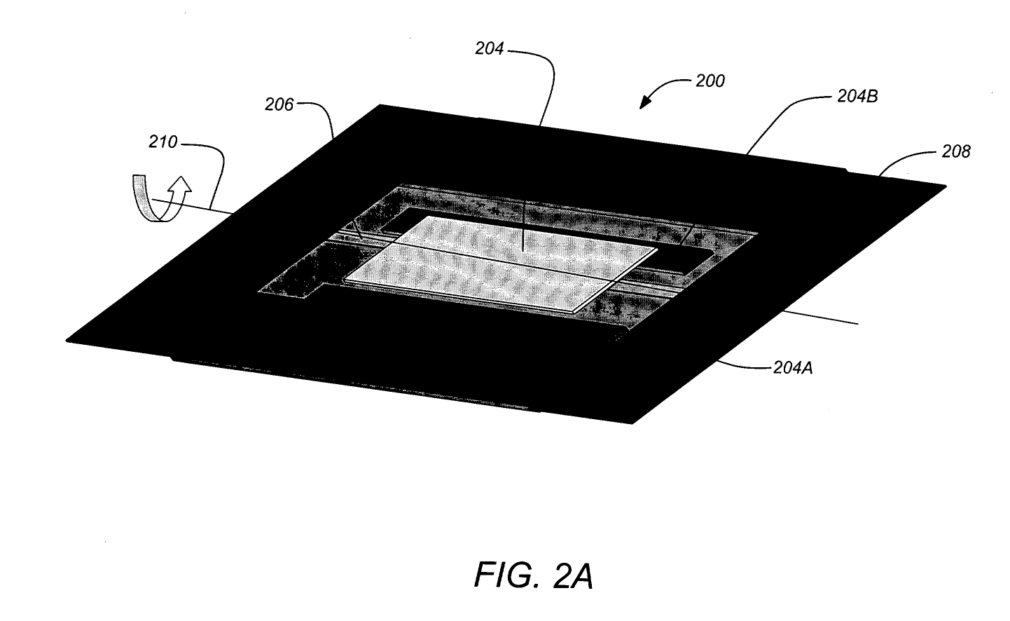

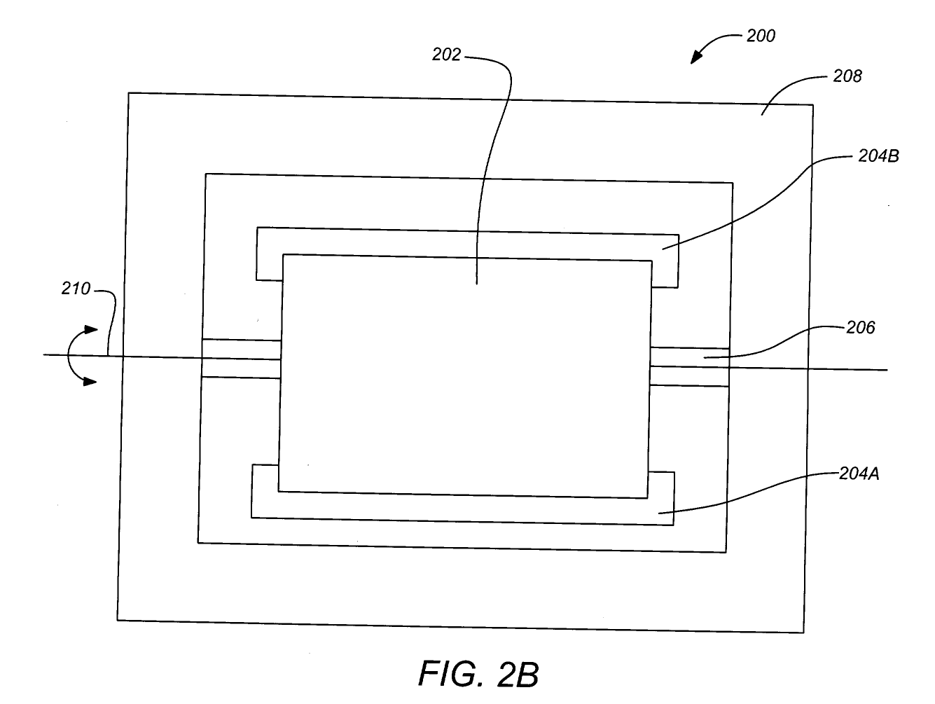

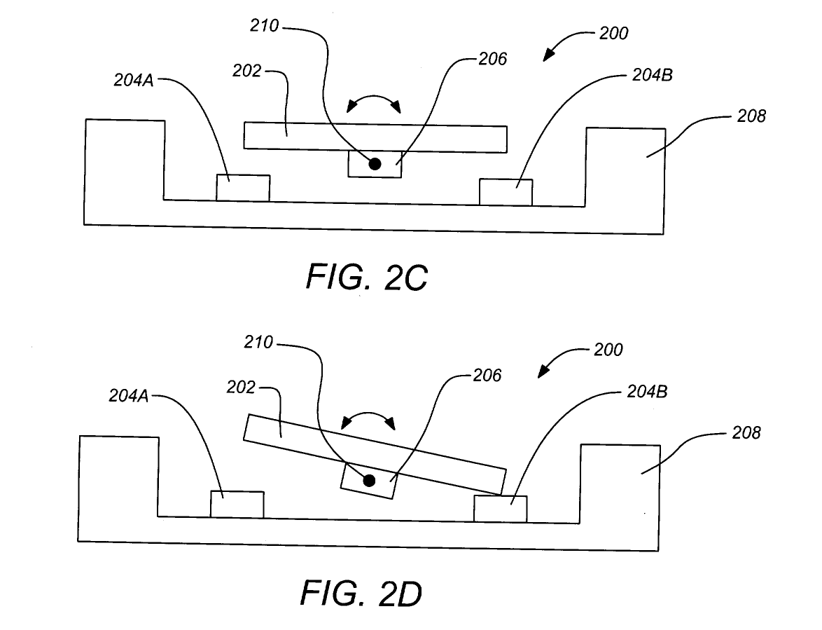

FIG. 2A illustrates an exemplary embodiment of the invention for a optical switch. The optical switch 200 is shown including a mirrored MEMS surface 202 which is used to reflect light. Movement of the mirrored surface 202 is actuated by electrostatic actuator plates 204A, 204B (collectively referenced as 204). The mirrored surface 202 is affixed to a movable support element 206 which disposes the mirrored surface above the electrostatic actuator plates 204 spanning the area across the surrounding substrate frame 208.

FIG. 2B illustrates a top view of the exemplary embodiment of the invention for the optical switch 200. In operation, the electrostatic actuator plates 204 are oppositely charged to move the mirrored surface 202 about an axis 210 through the movable support element 206.

FIGS. 2C and 2D illustrate a side view of the exemplary embodiment of the invention for the optical switch 200. The charge on the electrostatic actuator plates 204 causes the mirrored surface 202 to move from the position shown in FIG. 2C to the displaced position shown in FIG. 2D about an axis 210 through the support element 206. With embodiments of the present invention, the support element 206 is coated with an SMA material applied through a CVD process as discussed above. The support element 206 has a surface that is strained when the switch 200 is actuated. Thus, the SMA material applied over that surface serves to dampen the motion of the element 206 and reduce the bounce and other effects that delay settling of the device when actuated. Thus, the present invention allows selection of an optimized frequency response of the MEMS device.

Analysis of the MEMS device prior to application of the SMA material will determine the most effective areas of the device for SMA application as well as the appropriate thickness and SMA material type to use. The frequency response of the device or system can be either analytically derived or measured. Application of the SMA material will assist dampening the frequency response due to operational vibration or shock.

It is important to understand that the foregoing embodiment is only an example which uses an electrostatic actuator. The form of actuation and the type of device are only illustrative. Many other types of MEMS devices can also be used with the present invention employing different types of actuators. Typically, embodiments of the invention apply SMA material to MEMS devices manufactured on chips. For example, the actuator can also be an SMA actuator (actively driven), a bimetal actuator and/or a piezoelectric actuator. In a further example, other MEMS devices using the present invention can be produced by microstereolithography (MSL) as described in Julian W. Gardner et al., “Microsensors, MEMS, and Smart Devices”, 2001, pp. 216-218, which is incorporated by reference herein.

3. Operating Temperature and Selection of the Shape Memory Alloy

One important consideration in the selection and application of the SMA material is the operating temperature of the MEMS device. Ideally, the applied SMA material should be selected to have a transition temperature at the operating temperature of the MEMS device. However, because electrical power is readily available to the typical MEMS device chip, the SMA damper may be held at or near its transition temperature with an electrical heater while the remainder of the chip operates at a different temperature.

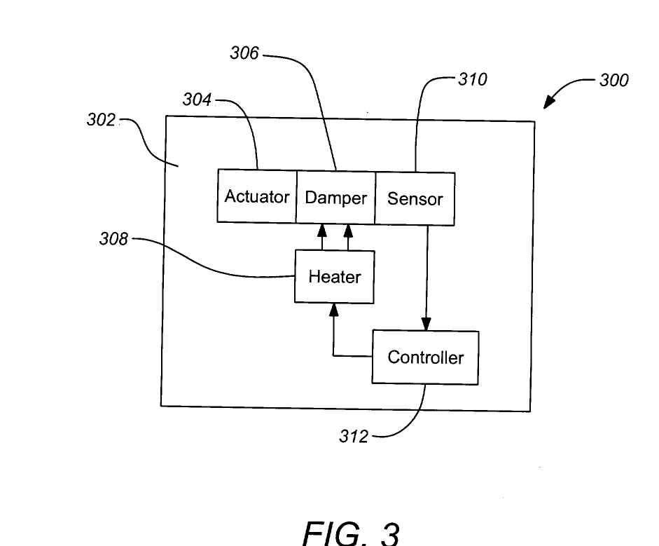

FIG. 3 is a block diagram of an exemplary embodiment of a temperature controlled MEMS device chip including an SMA damper. The MEMS system 300 includes a MEMS device chip 302 which includes an actuator 304 element and an associated SMA material damper 306 for damping the motion induced by the actuator 304. The damper 306 is thermodynamically coupled to an electric heater 308 and a proximately disposed temperature sensor 310 which monitors the temperature of the damper 306 in operation. The temperature sensor 310 is coupled to a controller 312 which drives the electric heater 308 (with on-chip power) to regulate the temperature of the damper 306 in response to temperature information from the sensor 310. The controller 312 need not be disposed on the MEMS chip 302 as shown. In other embodiments the temperature sensor 310 and controller 312 can also be integrated into a single unit.

Typically, the thermal design of MEMS system 300 is such that steady-state operational temperature of the damper 306 is below the transition temperature of the SMA material. Thus, the controller 312 can operate the electric heater 308 to raise the damper 306 temperature to a point near the transition temperature of the SMA material and optimize the operation of the MEMS system. Alternately, it is also possible for the electric heater 308 to be replaced with an electric cooler, such as a thermoelectric, thermionic or Peltier cooling device. In this case, the steady-state operational temperature of the damper 306 is above the transition temperature of the SMA material and the controller 312 drives the electric cooler to lower the damper 306 temperature.

As previously discussed, SMA materials have a number of identified transition temperatures. In a preferred embodiment the SMA material is selected to have a transition temperature substantially near the operating temperature of the MEMS device. This means that the operating temperature should be within an acceptable range of a particular transition temperature. Generally, a range of about 50 degrees F. is preferred. For example, the SMA material can be selected such that the operating temperature of the MEMS device (usually specified as a temperature range) matches a range beginning just below the Af temperature of the SMA material. This temperature range often includes a zone where SMA materials exhibit a superelastic behavior. This effect is caused by the stress-induce formation of some martensite above the materials transition temperature. Because the martensite is formed above its normal temperature, it immediately reverts to undeformed austenite as soon as the stress is removed. The overall effect is a non-reversible absorption of vibrational energy by the SMA damper via a hysteresis-like phenomonon between the opposing austenite-to-martensite and the martensite-to-austenite phase transitions. Thus, by selecting the SMA material to have a transition temperature near the operating temperature of the SMA material, the MEMS device will be dampened as the SMA material transitions between the austenite and martensite phases.

Accordingly, the SMA material should be selected to provide hysterisis around its operating temperature, and preferably near the operating temperature of the MEMS device chip. The SMA material hysteresis is characterized by the difference between the work absorbed during one half cycle of the vibration and the work released during the other half cycle. It is believed that the net work is significant enough to cause damping, although this theory has not been scientifically established. That is, it is believed that higher levels of stress are required to impart a strain to the stronger austenite that accordingly absorbs an amount of work. While the lower stress at which the strain is relieved in the transformed martensite phase, releases a smaller amount of work. Consequently, when a transition occurs, the SMA material changes shape which results in a reduction in the vibrational energy of the moving element of the MEMS device. The net work will be released as heat during the transformation. Accordingly, the SMA material should be selected with the corresponding increase in operating temperature (caused by the heat release) in mind.

This concludes the description including the preferred embodiments of the present invention. The foregoing description of the preferred embodiment of the invention has been presented for the purposes of illustration and description. It is not intended to be exhaustive or to limit the invention to the precise form disclosed. Many modifications and variations are possible in light of the above teaching.

It is intended that the scope of the invention be limited not by this detailed description, but rather by the claims appended hereto. The above specification, examples and data provide a complete description of the manufacture and use of the apparatus and method of the invention. Since many embodiments of the invention can be made without departing from the scope of the invention, the invention resides in the claims hereinafter appended.

What is claimed is:

1. A method comprising the steps of:
providing a microelectromechanical system (MEMS) device including an actuator and a movable element and having a frequency response; and
applying a shape memory alloy (SMA) material to the movable element of the MEMS device to provide passive damping to the MEMS device whereby the frequency response is modified.

2. The method of claim 1, wherein the actuator is selected from the group consisting of an SMA actuator, an electrostatic actuator, a bimetal actuator and a piezoelectric actuator.

3. The method of claim 1, wherein the movable element comprises a strainable surface and the SMA material is applied over the strainable surface.

4. The method of claim 1, wherein the frequency response is due to operational vibration.

5. The method of claim 1, wherein the frequency response is due to shock.

6. The method of claim 1, wherein the MEMS device is provided on a chip.

7. The method of claim 1, wherein the SMA material is applied by a CVD process.

8. The method of claim 1, wherein the the SMA material is applied by a sputtering process.

9. The method of claim 1, wherein the applied SMA material is selected from the group consisting of Ag—Cd, Au, Cd, Cu—Al—Ni, Cu—Sn, Cu—Zn, In—Ti, Ni—AL, Ni—Ti, Fe—Pt, Mn—Cu and Fe—Mn—Si alloys.

10. The method of claim 1, wherein the applied SMA material is selected from the group consisting of Niobium-Ruthenium and Tantalum-Rhenium.

11. The method of claim 1, wherein the movable element comprises a mirrored surface coupled to the actuator;
wherein the SMA material damps motion of the mirrored surface operating as an optical switch.

12. The method of claim 1, wherein the applied SMA material has a temperature substantially near a transition temperature of the applied SMA material.

13. The method of claim 12, wherein the temperature is in a range where the SMA material exhibits a substantially superelastic property.

14. The method of claim 12, wherein the temperature is approximately controlled to the transition temperature of the SMA material.

15. The method of claim 14, further comprising providing an electric heater for controlling the temperature of the SMA material.

16. The method of claim 14, further comprising providing an electric cooler for controlling the temperature of the SMA material.

17. An apparatus comprising:
a microelectromechanical system (MEMS) device including an actuator and a movable element and having a frequency response; and
a shape memory alloy (SMA) material applied to the movable element of the MEMS device to provide passive damping to modify the frequency response of the MEMS device.

18. The apparatus of claim 17, wherein the actuator is selected from the group consisting of an SMA actuator, an electrostatic actuator, a bimetal actuator and a piezoelectric actuator.

19. The apparatus of claim 17, wherein the movable element comprises a strainable surface and the SMA material is applied over the strainable surface.

20. The apparatus of claim 17, wherein the frequency response is due to operational vibration.

21. The apparatus of claim 17, wherein the frequency response is due to shock.

22. The apparatus of claim 17, wherein the MEMS device is on a chip.

23. The apparatus of claim 17, wherein the SMA material comprises a CVD process applied material.

24. The apparatus of claim 17, wherein the SMA material comprises a sputtered material.

25. The apparatus of claim 17, wherein the SMA material is selected from the group consisting of Ag—Cd, Au, Cd, Cu—Al—Ni, Cu—Sn, Cu—Zn, In—Ti, Ni—AL, Ni—Ti, Fe—Pt, Mn—Cu and Fe—Mn—Si alloys.

26. The apparatus of claim 17, wherein the applied SMA material is selected from the group consisting of Niobium-Ruthenium and Tantalum-Rhenium.

27. The apparatus of claim 17, wherein the movable element comprises a mirrored surface coupled to the actuator;
wherein the SMA material damps motion of the mirrored surface operating as an optical switch.

28. The apparatus of claim 17, wherein the SMA material has a temperature substantially near a transition temperature of the SMA material.

29. The apparatus of claim 28, wherein the temperature is in a range where the SMA material exhibits a substantially superelastic property.

30. The apparatus of claim 28, wherein the temperature is approximately controlled to a transition temperature of the SMA material.

31. The apparatus of claim 30, further comprising an electric heater for controlling the temperature of the SMA material.

32. The apparatus of claim 30, further comprising an electric cooler for controlling the temperature of the SMA material.
